(19) United States
(12) Patent Application Publication
(10) Pub. No.: US 2026/0222151 A1
(43) Pub. Date: Jul. 30, 2026

(54) FAST AND SEAMLESS HANDOVER BETWEEN TERRESTRIAL NETWORKS AND NON-TERRESTRIAL NETWORKS

(71) Applicant: QUALCOMM Incorporated, San Diego, CA (US)

(72) Inventors: Yi HUANG, San Diego, CA (US); Krishna Kiran MUKKAVILLI, San Diego, CA (US)

(21) Appl. No.: 19/036,837

(22) Filed: Jan. 24, 2025

(51) Int. Cl. H04L 5/00; H04W 24/10; H04W 72/21

(52) U.S. Cl. CPC H04L 5/0053; H04W 24/10; H04W 72/21

(57) ABSTRACT

Methods, systems, and devices for wireless communications are described. A user equipment (UE) may transmit an uplink reference signal. A first network entity may perform a first set of measurements of the uplink reference signal and may receive, from a second network entity, a second set of measurements of the uplink reference signal performed by the second network entity. The first network entity may calculate a propagation delay offset value and a pathloss offset value based on the first and second sets of measurements. The first network entity may transmit, and the UE may receive, a cell switch medium access control (MAC) control element (CE) indicating the propagation delay offset value and the pathloss offset value. The UE may switch from a first cell associated with the first network entity to a second cell associated with the second network entity based on applying the offset values.

### FIELD OF TECHNOLOGY

The following relates to wireless communications, including fast and seamless handover between terrestrial networks (TNs) and non-terrestrial networks (NTNs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting an uplink reference signal, receiving, based on transmitting the uplink reference signal, a medium access control (MAC) control element (CE) indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, and switching from a first cell associated with the first network entity to a second cell associated with the second network entity based on applying the propagation delay offset value and the pathloss offset value.

A UE for wireless communications is described. The UE may include one or more memories storing processor executable code, and one or more processors coupled with the one or more memories. The one or more processors may individually or collectively be operable to execute the code to cause the UE to transmit an uplink reference signal, receive, based on transmitting the uplink reference signal, a medium access control MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, and switch from a first cell associated with the first network entity to a second cell associated with the second network entity based on applying the propagation delay offset value and the pathloss offset value.

Another UE for wireless communications is described. The UE may include means for transmitting an uplink reference signal, means for receiving, based on transmitting the uplink reference signal, a medium access control MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, and means for switching from a first cell associated with the first network entity to a second cell associated with the second network entity based on applying the propagation delay offset value and the pathloss offset value.

A non-transitory computer-readable medium storing code for wireless communications is described. The code may include instructions executable by one or more processors to transmit an uplink reference signal, receive, based on transmitting the uplink reference signal, a medium access control MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, and switch from a first cell associated with the first network entity to a second cell associated with the second network entity based on applying the propagation delay offset value and the pathloss offset value.

In some examples of the method, UEs, and non-transitory computer-readable medium described herein, transmitting the uplink reference signal may include operations, features, means, or instructions for broadcasting a single port uplink reference signal on an omni-directional beam.

Some examples of the method, UEs, and non-transitory computer-readable medium described herein may further include operations, features, means, or instructions for adjusting a downlink reception timing in accordance with the propagation delay offset value based on applying the propagation delay offset value and receiving downlink signaling from the second network entity based on adjusting the downlink reception timing.

Some examples of the method, UEs, and non-transitory computer-readable medium described herein may further include operations, features, means, or instructions for adjusting an uplink transmission timing in accordance with the propagation delay offset value based on applying the propagation delay offset value and transmitting uplink signaling to the second network entity based on adjusting the uplink transmission timing.

Some examples of the method, UEs, and non-transitory computer-readable medium described herein may further include operations, features, means, or instructions for adjusting an uplink transmission power in accordance with the pathloss offset value based on applying the pathloss offset value and transmitting uplink signaling to the second network entity based on adjusting the uplink transmission power.

Some examples of the method, UEs, and non-transitory computer-readable medium described herein may further include operations, features, means, or instructions for receiving control signaling allocating resources for the uplink reference signal for triggering cell switching, where transmitting the uplink reference signal may be based on the control signaling.

In some examples of the method, UEs, and non-transitory computer-readable medium described herein, the MAC-CE may be a low layer triggered mobility cell switch command MAC-CE including a timing advance command field, and the timing advance command field includes the propagation delay offset value.

In some examples of the method, UEs, and non-transitory computer-readable medium described herein, the MAC-CE includes a field carrying a set of bits indicating the propagation delay offset value, a first subset of the set of bits indicating a quantity of slots of the propagation delay offset value and a second subset of the set of bits indicating a quantity of symbols of the propagation delay offset value and the propagation delay offset value includes a sum of the quantity of slots and the quantity of symbols.

Some examples of the method, UEs, and non-transitory computer-readable medium described herein may further include operations, features, means, or instructions for calculating the propagation delay offset value based on the first subset of the set of bits and the second subset of the set of bits, where applying the propagation delay offset value may be based on calculating the propagation delay offset value.

In some examples of the method, UEs, and non-transitory computer-readable medium described herein, one of the first network entity or the second network entity includes a non-terrestrial network entity and the other of the first network entity or the second network entity includes a terrestrial network entity.

A method for wireless communications by a first network entity is described. The method may include performing a first set of one or more measurements of an uplink reference signal received from a UE, receiving, from a second network entity, an indication of a second set of one or more measurements of the uplink reference signal performed by the second network entity, calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements, and transmitting a medium access control MAC-CE indicating for the UE to perform a cell switch, where the MAC-CE includes an indication of the propagation delay offset value and the pathloss offset value.

A first network entity for wireless communications is described. The first network entity may include one or more memories storing processor executable code, and one or more processors coupled with the one or more memories. The one or more processors may individually or collectively be operable to execute the code to cause the first network entity to perform a first set of one or more measurements of an uplink reference signal received from a UE, receive, from a second network entity, an indication of a second set of one or more measurements of the uplink reference signal performed by the second network entity, calculate a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements, and transmit a medium access control MAC-CE indicating for the UE to perform a cell switch, where the MAC-CE includes an indication of the propagation delay offset value and the pathloss offset value.

Another first network entity for wireless communications is described. The first network entity may include means for performing a first set of one or more measurements of an uplink reference signal received from a UE, means for receiving, from a second network entity, an indication of a second set of one or more measurements of the uplink reference signal performed by the second network entity, means for calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements, and means for transmitting a medium access control MAC-CE indicating for the UE to perform a cell switch, where the MAC-CE includes an indication of the propagation delay offset value and the pathloss offset value.

A non-transitory computer-readable medium storing code for wireless communications is described. The code may include instructions executable by one or more processors to perform a first set of one or more measurements of an uplink reference signal received from a UE, receive, from a second network entity, an indication of a second set of one or more measurements of the uplink reference signal performed by the second network entity, calculate a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements, and transmit a medium access control (MAC) control element (CE) indicating for the UE to perform a cell switch, where the MAC-CE includes an indication of the propagation delay offset value and the pathloss offset value.

Some examples of the method, first network entities, and non-transitory computer-readable medium described herein may further include operations, features, means, or instructions for transmitting the first set of one or more measurements to the second network entity based on performing the first set of one or more measurements.

Some examples of the method, first network entities, and non-transitory computer-readable medium described herein may further include operations, features, means, or instructions for exchanging one or more coordination messages with the second network entity via a backhaul link, where calculating the propagation delay offset value and the pathloss offset value, transmitting the MAC-CE, or both may be based on the one or more coordination messages.

In some examples of the method, first network entities, and non-transitory computer-readable medium described herein, one of the first network entity or the second network entity includes a non-terrestrial network entity and the other of the first network entity or the second network entity includes a terrestrial network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports fast and seamless handover between terrestrial networks (TNs) and non-terrestrial networks (NTNs) in accordance with one or more aspects of the present disclosure.

FIG. 2 shows an example of a wireless communications system that supports fast and seamless handover between TNs and NTNs in accordance with one or more aspects of the present disclosure.

FIG. 3 shows an example of a process flow that supports fast and seamless handover between TNs and NTNs in accordance with one or more aspects of the present disclosure.

FIGS. 4 and 5 show block diagrams of devices that support fast and seamless handover between TNs and NTNs in accordance with one or more aspects of the present disclosure.

FIG. 6 shows a block diagram of a communications manager that supports fast and seamless handover between TNs and NTNs in accordance with one or more aspects of the present disclosure.

FIG. 7 shows a diagram of a system including a device that supports fast and seamless handover between TNs and NTNs in accordance with one or more aspects of the present disclosure.

FIGS. 8 and 9 show block diagrams of devices that support fast and seamless handover between TNs and NTNs in accordance with one or more aspects of the present disclosure.

FIG. 10 shows a block diagram of a communications manager that supports fast and seamless handover between TNs and NTNs in accordance with one or more aspects of the present disclosure.

FIG. 11 shows a diagram of a system including a device that supports fast and seamless handover between TNs and NTNs in accordance with one or more aspects of the present disclosure.

FIGS. 12 and 13 show flowcharts illustrating methods that support fast and seamless handover between TNs and NTNs in accordance with one or more aspects of the present disclosure.

### DETAILED DESCRIPTION

In some wireless communications systems, a terrestrial network (TN) and a non-terrestrial network (NTN) may correspond to (e.g., provide coverage to) a same geographic area. In such systems, both the TN and the NTN may be available for wireless communications with one or more user equipments (UEs) (e.g., located in the same geographic area). In some cases, a TN (e.g., a TN operator) and an NTN (e.g., an NTN operator) may collaborate to adjust communication traffic (e.g., to offload UEs between the TN and the NTN). Such techniques may include or be referred to as radio access network (RAN) sharing. For example, the TN may experience network congestion, and the wireless communications system may accordingly support handover of UEs from the TN to the NTN (e.g., or handover from the NTN to the TN). Within a TN, handover between cells may occur when a UE is located at or approaching a cell edge, and a UE may switch from a source cell to a target cell when experiencing poor connectivity to the source cell. However, handover between a TN and an NTN may occur more frequently (e.g., frequent UE offloading), and a large propagation delay difference, pathloss difference, or both between the UE and a TN network entity and the UE and an NTN network entity may impede fast and seamless handover between the TN and the NTN.

Accordingly, techniques described herein support fast and seamless handover between a TN and an NTN. Described techniques for handover between a TN and an NTN may account for the propagation delay difference and pathloss difference between the UE and the TN network entity and the UE and the NTN, and may allow UEs to adjust downlink reception timing, uplink transmission timing, and uplink transmission power accordingly to reduce system latency and improve coordination between networks. In some examples, a UE may receive control signaling allocating resources for an uplink reference signal for triggering cell switching. The UE may transmit the uplink reference signal to a TN network entity and an NTN network entity via the allocated resources. The TN network entity and the NTN network entity may each perform propagation delay and pathloss measurements on the uplink reference signal, and the TN network entity and the NTN network entity may exchange these measurements to calculate a propagation delay offset value and a pathloss offset value. At least one of the TN network entity and the NTN network entity may transmit a control message (e.g., a medium access control (MAC) control element (CE)) indicating for the UE to perform a cell switch. The control message may include the propagation delay offset value and the pathloss offset value. The UE may switch from a first cell associated with one of the TN network entity or the NTN network entity to a second cell associated with the other of the TN network entity or the NTN network entity based at least in part on applying the propagation delay offset value and the pathloss offset value. That is, the UE may adjust a downlink reception timing and an uplink transmission timing based on the propagation delay offset value, and may adjust an uplink transmission power based on the pathloss offset value. Such techniques may allow a wireless communications system to support fast and seamless handover between a TN and an NTN by accounting for differences in propagation delay and pathloss between the TN and the NTN to reduce latency and improve coordination between networks. Such techniques may support improved traffic control and coordination across networks, resulting in improved throughout, decreased system congestion, decreased system latency, more efficient use of available system resources, and improved user experience.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to fast and seamless handover between TNs and NTNs.

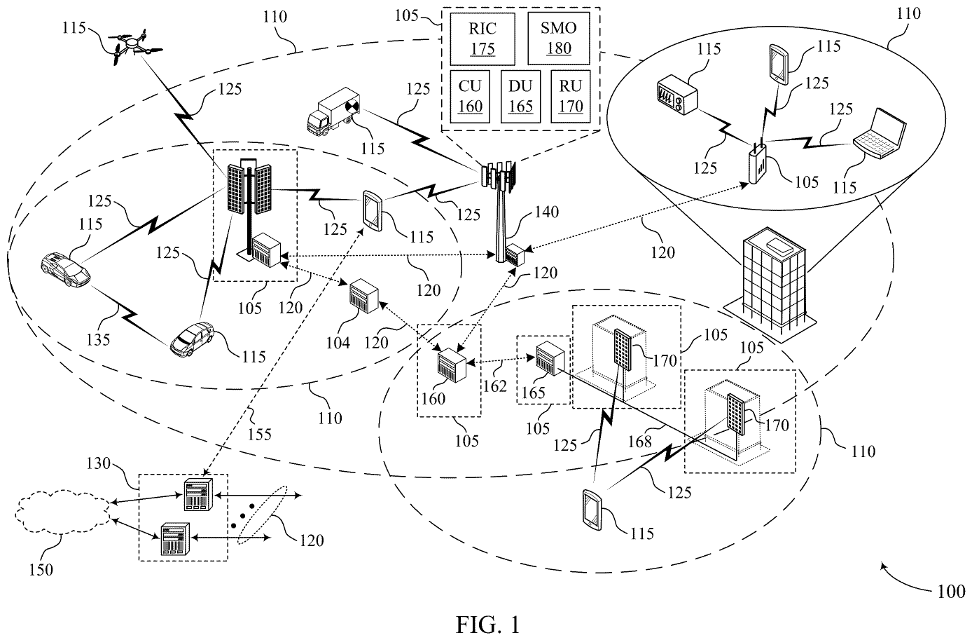

FIG. 1 shows an example of a wireless communications system 100 that supports fast and seamless handover between TNs and NTNs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support fast and seamless handover between TNs and NTNs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support both a TN and an NTN, and each the TN and the NTN may be associated with one or more network entities 105. In some cases, a TN and an NTN may collaborate to offload UEs 115 between the TN and the NTN. In such cases, handover between the TN and the NTN may be based on transmission and measurement of uplink reference signals. For example, a UE 115 may transmit an uplink measurement signal that is received by both a first network entity 105 associated with the TN and a second network entity 105 associated with the NTN. The first network entity and the second network entity may each perform one or more measurements (e.g., pathloss, propagation delay) on the uplink reference signal. The first network entity and the second network entity may coordinate to exchange the one or more measurements, calculate a propagation delay offset value and a pathloss offset value, and transmit a cell switch command MAC-CE to the UE 115. The MAC-CE may include the propagation delay offset value and the pathloss offset value, which the UE 115 may use to adjust transmission and reception parameters for communications with a target cell.

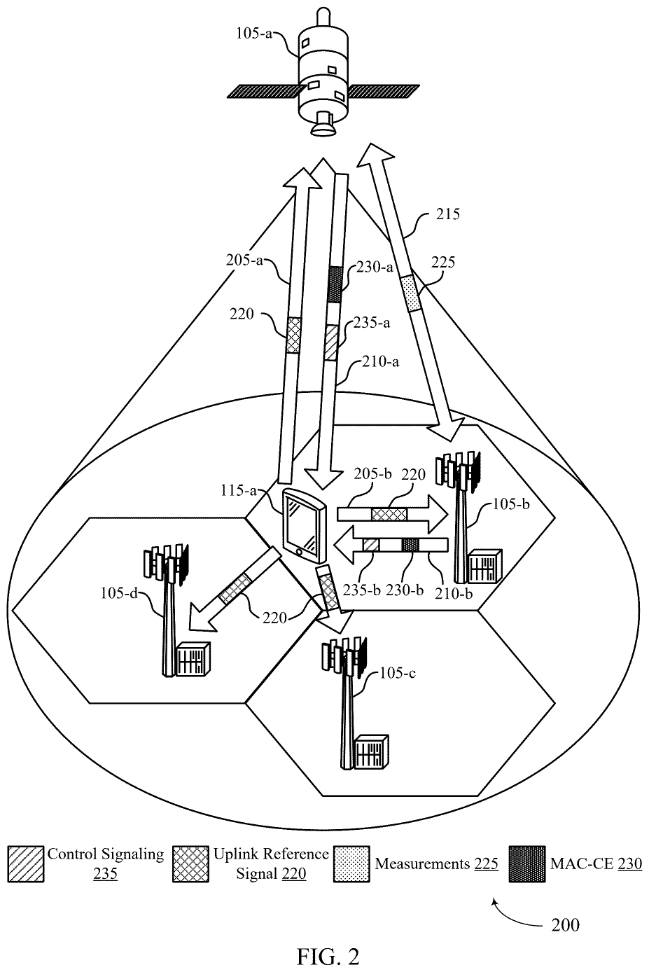

FIG. 2 shows an example of a wireless communications system 200 that supports fast and seamless handover between TNs and NTNs in accordance with one or more aspects of the present disclosure. In some examples, wireless communications system 200 may implement, or be implemented by, aspects of wireless communications system 100. For example, the wireless communications system 200 may include a UE 115-a and network entities 105-a, 105-b, 105-c and 105-d, which may be examples of network entities 105 (e.g., gNBs, satellites), UEs 115, and other wireless devices as described with reference to FIG. 1.

In some examples of the wireless communications system 200, the UE 115-a may communicate with the network entity 105-a and the network entity 105-b via uplink connections 205 and downlink connections 210, and the network entity 105-a and the network entity 105-b may communicate with each other via an interface 215 (e.g., a backhaul link, an Xn interface, or other higher layer signaling). The network entity 105-a (e.g., a satellite) may be associated with an NTN, and the network entity 105-b, the network entity 105-c, and the network entity 105-d may be associated with a TN. Each of the network entity 105-b, the network entity 105-c, and the network entity 105-d may provide coverage for a cell associated with a respective geographic area.

In some examples, the TN and the NTN may overlay a same geographic area. In such cases, the TN and the NTN may both be available to the UE 115-a, and the TN operator and the NTN operator may collaborate to offload UEs between the TN and the NTN (e.g., RAN sharing). For example, the TN network may experience network congestion and offload UEs to the NTN. Additionally, or alternatively, the UE 115-a may switch between the TN and the NTN (e.g., based on network coverage).

In some cases, the wireless communications system 200 may support handover between cells of the TN. In such cases, handover may occur at an edge of a cell, and the UE 115-a may switch to a target cell (e.g., reactively) when experiencing poor connectivity to a source cell (e.g., based on mobility-based measurements of a downlink reference signal). For example, the UE 115-a may receive downlink reference signals, and may perform and report measurements based thereon to one or more network entities 105. A handover instruction may be received based on the UE measurements, and the UE may also perform measurements to determine timing adjustments etc. for handover from a current source cell (e.g., corresponding to the network entity 105-b) to a target cell (e.g., corresponding to the network entity 105-d).

Additionally, or alternatively, as described herein, the wireless communications system 200 may support handover between the TN and the NTN (e.g., to reduce network congestion). Handover between the TN and the NTN may occur more frequently than handover between cells of the TN (e.g., as a result of traffic, or satellite mobility for the NTN, among other examples), and differences in propagation delay and pathloss between the TN and the NTN (e.g., due to a larger distance between the UE 115-a and network entities of the NTN) may hinder fast and seamless handover between the TN and the NTN. For example, a propagation delay, pathloss, or both, for communications between the UE 115-a and the network entity 105-a may be relatively larger than a propagation delay, pathloss, or both, for communications between the UE 115-a and the network entity 105-b. The larger propagation delay and pathloss for communications with the network entity 105-a may result from the significantly larger distance between the UE 115-a and the network entity 105-a (e.g., as compared to the relatively smaller distance between the UE 115-a and the network entity 105-b). An uplink transmission timing, a downlink reception timing, or an uplink transmission power for communications between the UE 115-a and the network entity 105-a may be different than those for communications between the UE 115-a and the network entity 105-b (e.g., due to differences in propagation delay and pathloss).

For example, a pathloss between the UE 115-a and the network entity 105-a may be greater than a pathloss between the UE 115-a and the network entity 105-b. If the UE 115-a were to switch from the network entity 105-b to the network entity 105-a, and were to use a same transmit power for uplink transmissions to the network entity 105-a as the transmit power used to transmit uplink transmissions to the network entity 105-b, such uplink transmissions may be more likely to fail (e.g., or the network entity 105-a may fail to receive or decode some or all of such an uplink transmissions) due to the larger pathloss between the UE 115-a and the network entity 105-a. Similarly, due to the larger difference in distance between the UE 115-a and the network entity 105-a (e.g., as compared to the distance between the UE 115-a and the network entity 105-b), the UE 115-a may not be able to use a same transmission timing or a same reception timing for uplink and downlink signaling when switching between the network entity 105-a and the network entity 105-b.

Because of the differences in distance, pathloss, transmission timing, reception timing, etc., a UE 115-a may perform multiple measurements (e.g., of downlink signals) from various network entities 105 to determine and calculate a new transmission power, reception power, pathloss, transmit power, etc. However, such measurements and calculations may result in extended delays for each potential cell switch, and may also result in increased signaling overhead, signaling congestion, and inefficient use of system resources. Such increased delays and inefficiencies may be prohibitive to quick and seamless handovers between NTN network entities 105 and TN network entities 105 (e.g., resulting in loss of ability to offload traffic, manage traffic flow, increase throughout, and improve user experience).

Accordingly, the wireless communications system 200 may support fast, seamless handover between the TN and the NTN in accordance with techniques described herein. The UE 115-a may receive control signaling 235 allocating resources for an uplink reference signal 220 for triggering cell switching. For example, the network entity 105-a may transmit, via the downlink connection 210-a, control signaling 235-a configuring the UE 115-a with resources for transmission of the uplink reference signal 220, which may serve to trigger a cell switch. Additionally, or alternatively, the network entity 105-b may transmit, via the downlink connection 210-b, control signaling 235-b allocating resources to the UE 115-a for transmission of the uplink reference signal 220.

The UE 115-a may transmit (e.g., via the allocated resources), the uplink reference signal 220 to the network entity 105-a and the network entity 105-b via the uplink connection 205-a and the uplink connection 205-b, respectively. In some examples, the UE 115-a may transmit a single port uplink reference signal on an omni-directional beam (e.g., in a broadcast fashion). That is, the UE 115-a may broadcast a single uplink reference signal that reaches both the network entity 105-a and the network entity 105-b, thereby reducing overhead. The omni-directional beam may additionally allow the uplink reference signal 220 to reach the network entity 105-c and the network entity 105-d (e.g., without sending multiple distinct transmissions via various resources). Additionally, or alternatively, the UE 115-a may transmit a multi-port uplink reference signal and use directional beamforming to transmit the uplink reference signal 220 to each the network entity 105-a and the network entity 105-b. Multi-port transmission of the uplink reference signal 220 may increase the received strength of the uplink reference signal 220 (e.g., transmitted at different time resources).

The network entity 105-a and the network entity 105-b may each receive the uplink reference signal 220, and may perform one or more measurements on the uplink reference signal 220. That is, the network entity 105-a may measure, calculate, or otherwise determine a first propagation delay and a first pathloss associated with communications between the UE 115-a and the network entity 105-a (e.g., based on the received uplink reference signal 220), and the network entity 105-b may likewise measure, calculate, or determine a second propagation delay and a second pathloss associated with communications between the UE 115-a and the network entity 105-b (e.g., based on the uplink reference signal 220). The first propagation delay and the first pathloss may be dependent on the distance between the UE 115-a and the network entity 105-a, and the second propagation delay and the second pathloss may be dependent on the distance between the UE 115-a and the network entity 105-b. For example, the network entity 105-a may measure a greater propagation delay and a greater pathloss due to a larger distance between the UE 115-a and the network entity 105-a.

The network entity 105-a and the network entity 105-b may exchange the one or more measurements 225 via the interface 215. In some examples, the network entity 105-b may transmit the second propagation delay and the second pathloss to the network entity 105-a via the interface 215. Additionally, or alternatively, the network entity 105-a may transmit the first propagation delay value and the first pathloss value to the network entity 105-b via the interface 215.

The network entity 105-a, the network entity 105-b, or both may calculate a propagation delay offset value and a pathloss offset value based on the measurements 225. For example, the network entity 105-a may calculate a propagation delay offset value based on a difference between the first propagation delay and the second propagation delay and a pathloss offset value based on a difference between the first pathloss and the second pathloss. The propagation delay offset value may be based on a difference in reception timing of the uplink reference signal 220, and the pathloss offset value may be based on a difference in received power of the uplink reference signal 220. In some examples, the network entity 105-a, the network entity 105-b, or both, may transmit an indication of the calculated propagation delay offset value, the calculated pathloss offset value, or both, to each other. For example, the network entities 105 may calculate the propagation delay offset value and the pathloss offset value based on exchanged raw measurements or timing information (e.g., the measurements 225), or one or both of the network entities 105 may calculate the propagation delay offset value and the pathloss offset value and then transmit an indication of the calculated values to one or more other network entities 105.

In some examples, the network entity 105-a may transmit, via the downlink connection 210-a, a control message (e.g., a MAC-CE 230-a) indicating for the UE 115-a to perform a cell switch. Additionally, or alternatively, the network entity 105-b may transmit a control message (e.g., a MAC-CE 230-b) to the UE 115-a (e.g., via the downlink connection 210-b) indicating for the UE 115-a to perform the cell switch. That is, the MAC-CE indicating for the UE 115-a to perform the cell switch may be transmitted by the source cell, the target cell, or both. The MAC-CE 230 may include the propagation delay offset value and the pathloss offset value. In some cases, the MAC-CE 230 may be a low layer triggered mobility (LTM) cell switch command MAC-CE, and the propagation delay offset value may be included in one or more fields (e.g., may replace an existing Timing Advance command). In some examples, the MAC-CE 230 may be an L3 triggered cell switch command MAC-CE including one or more fields for the propagation delay offset value and the pathloss offset value.

In some implementations, the MAC-CE 230 may include a two-part field indicating the propagation delay offset value (e.g., to reduce the number of bits representing the propagation delay offset value). That is, the propagation delay offset may indicate an amount of time in terms of an absolute time value, a quantity of symbols, or the like. However, if the quantity of symbols is large, such an indication may result in use of a large quantity of bits and increased signaling overhead. In some examples, the MAC-CE 230 may include a field (e.g., a set of bits) including a first subset of bits indicating a quantity of a first time interval (e.g., X slots) and a second subset of bits indicating a quantity a second time interval (e.g., Y symbols, such as OFDM symbols). In such implementations, the total propagation delay offset value may be represented as a summation of the first quantity of slots (e.g., in which case the first quantity of slots can be converted into a quantity of symbols) and the second quantity of symbols (e.g., in which case the total propagation delay offset can be interpreted as a total quantity of symbols). In such examples, the total propagation delay offset value may be represented as the first value multiplied by a conversion value plus the second value (e.g., X*14+Y symbols), where the total propagation delay offset value is expressed in units of OFDM symbols.

Upon receiving the MAC-CE 230, the UE 115-a may adjust one or more parameters for communication with a target cell based on the propagation delay offset value and the pathloss offset value. For example, the UE 115-a may adjust a downlink reception timing, an uplink transmission timing, or both based on the propagation delay offset value. In some cases, the UE 115-a may calculate the propagation delay offset value based on the first subset of bits and the second subset of bits in the two-part field. Additionally, or alternatively, the UE 115-a may adjust an uplink transmission power in accordance with the pathloss offset value.

The UE 115-a may switch from a source cell to a target cell based on applying the propagation delay offset value and the pathloss offset value received in the MAC-CE 230. For example, the UE 115-a may switch from a source cell associated with the network entity 105-a to a target cell associated with the network entity 105-b, or the UE 115-a may switch from a source cell associated with the network entity 105-b to a target cell associated with the network entity 105-a. To support quick handover without relying on additional time delays, measurements, or the like, the UE 115-a may simply apply the propagation delay offset value to uplink and downlink timing, and may apply the pathloss offset value to a calculated transmit power, and may seamlessly initiate wireless communications with the target cell. Thus, application of the propagation delay offset value and the pathloss offset value may facilitate a fast and seamless handover and allow the UE 115-a to communicate efficiently with the target cell.

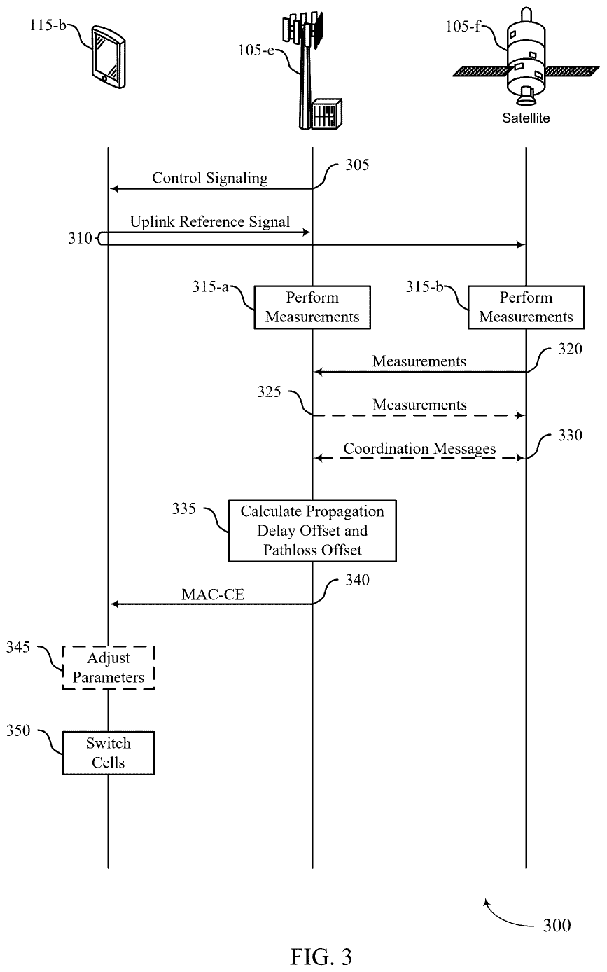

FIG. 3 shows an example of a process flow 300 that supports fast and seamless handover between TNs and NTNs in accordance with one or more aspects of the present disclosure. The process flow 300 may implement or be implemented to realize aspects of the wireless communications systems 100 or 200. For example, the process flow 300 illustrates transmission and measurement of an uplink reference signal, as described with reference to FIG. 2. The process flow 300 may include a UE 115-b, a network entity 105-e, and a network entity 105-f, which may be examples of corresponding devices described herein. For example, the UE 115-b may be an example of the UE 115-a, as illustrated in FIG. 2. Similarly, the network entity 105-e and the network entity 105-f may be examples of the network entities 105-a, 105-b, 105-c, 105-d, as illustrated in FIG. 2.

In the following description of the process flow 300, the operations between the UE 115-b, the network entity 105-e, and the network entity 105-f may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the UE 115-b may receive control signaling allocating resources for transmission of an uplink reference signal (e.g., for triggering cell switching). That is, the UE 115-b may receive an indication of time and frequency resources on which to transmit one or more uplink reference signals. In some implementations, the network may transmit the control signaling. For example, the network entity 105-e or the network entity 105-f may transmit the control signaling (e.g., via a source cell). In some examples, the UE 115-b may transmit capability information indicating that it is able to support such reference signaling, and may receive the control signaling allocating the resources based at least in part on transmitting the capability information.

At 310, the UE 115-b may transmit, and the network entities 105-e and 105-f may receive, the uplink reference signal. The UE 115-b may transmit the uplink reference signal on the resources indicated in the control signaling at 305. In some cases, the UE 115-b may transmit a single port uplink reference signal on an omni-directional beam (e.g., in a broadcast fashion). That is, the UE 115-b may transmit a single uplink reference signal that reaches both the network entity 105-e and the network entity 105-f, thereby reducing overhead. Additionally, or alternatively, the UE 115-b may transmit a multi-port uplink reference signal and use directional beamforming to transmit the uplink reference signal to each the network entity 105-e and the network entity 105-f. Multi-port transmission of the uplink reference signal may increase the received strength of the uplink reference signal.

At 315, the network entity 105-e and the network entity 105-f may perform one or more measurements on the uplink reference signal received at 310. For example, at 315-a, the network entity 105-e may measure a first propagation delay and a first pathloss associated with communications between the UE 115-b and the network entity 105-e. Likewise, at 315-b, the network entity 105-f may measure a second propagation delay and a second pathloss associated with communications between the UE 115-b and the network entity 105-f. The first propagation delay and the first pathloss may be dependent on the distance between the UE 115-b and the network entity 105-e, and the second propagation delay and the second pathloss may be dependent on the distance between the UE 115-b and the network entity 105-f. For example, the network entity 105-e may be a TN network entity and the network entity 105-f may be an NTN network entity (e.g., satellite), and the network entity 105-f may accordingly measure a greater propagation delay and a greater pathloss (e.g., due to a larger distance between the UE 115-b and the network entity 105-f).

At 320, the network entity 105-e may receive a first set of one or more measurements from the network entity 105-f. For example, the network entity 105-f may transmit the second propagation delay and the second pathloss to the network entity 105-e. The network entity 105-f may transmit, and the network entity 105-e may receive, the first set of one or more measurements via a backhaul link (e.g., an Xn interface).

At 325, the network entity 105-e may transmit a second set of one or more measurements to the network entity 105-f. For example, the network entity 105-e may transmit the first propagation delay and the first pathloss to the network entity 105-f. The network entity 105-e may transmit, and the network entity 105-f may receive, the second set of one or more measurements via the backhaul link.

At 330, the network entity 105-e may exchange one or more coordination messages with the network entity 105-f. The network entity 105-e and the network entity 105-f may exchange the one or more coordination messages via the backhaul link. The one or more coordination messages may indicate for the network entity 105-e, the network entity 105-f, or both to calculate a propagation delay offset value and a pathloss offset value, to transmit a MAC-CE indicating a cell switch to the UE 115-b, or both. In some examples, one network entity (e.g., the network entity 105-e) may transmit the indication of the measurements (e.g., at 325) and the other network entity (e.g., the network entity 105-f) may transmit an indication of the measured propagation delay offset value and the pathloss offset value. In some examples, both network entities 105 may exchange measurements, coordination messages, or both.

At 335, the network entity 105-e may calculate a propagation delay offset value and a pathloss offset value. That is, the network entity 105-e may calculate a propagation delay offset value corresponding to an offset between the first propagation delay and the second propagation delay and a pathloss offset value corresponding to an offset between the first pathloss and the second pathloss. For example, the propagation delay offset value may be based on a difference in reception timing of the uplink reference signal, and the pathloss offset value may be based on a difference in received power of the uplink reference signal.

At 340, the network entity 105-e may transmit, to the UE 115-b, a control message (e.g., a MAC-CE) indicating for the UE 115-b to perform a cell switch. The MAC-CE may include an indication of the propagation delay offset value and the pathloss offset value. In some cases, the MAC-CE may be an LTM cell switch command MAC-CE, and the propagation delay offset value may replace an existing Timing Advance command. In some examples, the MAC-CE may be an L3 triggered cell switch command MAC-CE.

In some implementations, the MAC-CE may include a two-part field indicating the propagation delay offset value (e.g., to reduce the number of bits representing the propagation delay offset value). That is, the MAC-CE may include a field carrying a set of bits including a first subset of bits indicating a quantity X of slots of the propagation delay offset value and a second subset of bits indicating a quantity Y of symbols (e.g., OFDM symbols) of the propagation delay offset value. In such implementations, the total propagation delay offset value may be represented as: X*14+Y, where the total propagation delay offset value is expressed in units of OFDM symbols.

At 345, the UE 115-b may adjust one or more parameters based on receiving the MAC-CE at 340. That is, the UE 115-b may adjust parameters for communications with a target cell in accordance with the propagation delay offset value, the pathloss offset value, or both. For example, the UE 115-b may adjust, in accordance with the propagation delay offset value, a downlink reception timing, an uplink transmission timing, or both based on applying the propagation delay offset value. In some cases, the UE 115-b may calculate the propagation delay offset value based on the first subset of bits and the second subset of bits in the two-part field. Additionally, or alternatively, the UE 115-b may, based on applying the pathloss offset value, adjust an uplink transmission power in accordance with the pathloss offset value.

At 350, the UE 115-b may switch from a source cell to a target cell based on applying the propagation delay offset value and the pathloss offset value received in the MAC-CE at 340. For example, the UE 115-b may switch from a source cell associated with the network entity 105-e to a target cell associated with the network entity 105-f. In some cases, the UE 115-b may transmit uplink signaling to the network entity associated with the target cell (e.g., network entity 105-e, network entity 105-f) based on adjusting the uplink transmission power, the uplink transmission timing, or both, and the UE 115-b may receive downlink signaling from the network entity associated with the target cell based on adjusting the downlink reception timing. Application of the propagation delay offset value and the pathloss offset value may facilitate a fast and seamless handover and allow the UE 115-b to communicate efficiently with the target cell.

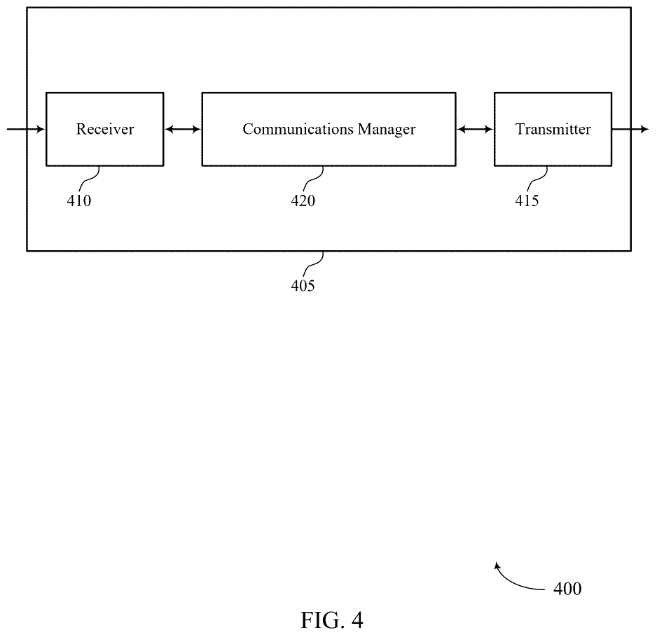

FIG. 4 shows a block diagram 400 of a device 405 that supports fast and seamless handover between TNs and NTNs in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to fast and seamless handover between TNs and NTNs). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to fast and seamless handover between TNs and NTNs). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of fast and seamless handover between TNs and NTNs as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving control signaling allocating resources for an uplink reference signal for triggering cell switching, where transmitting the uplink reference signal is based at least in part on the control signaling. The communications manager 420 is capable of, configured to, or operable to support a means for transmitting the uplink reference signal. The communications manager 420 is capable of, configured to, or operable to support a means for receiving, based on transmitting the uplink reference signal, a MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity. The communications manager 420 is capable of, configured to, or operable to support a means for switching from a first cell associated with the first network entity to a second cell associated with the second network entity based on applying the propagation delay offset value and the pathloss offset value.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources when switching between TN connections and NTN connections.

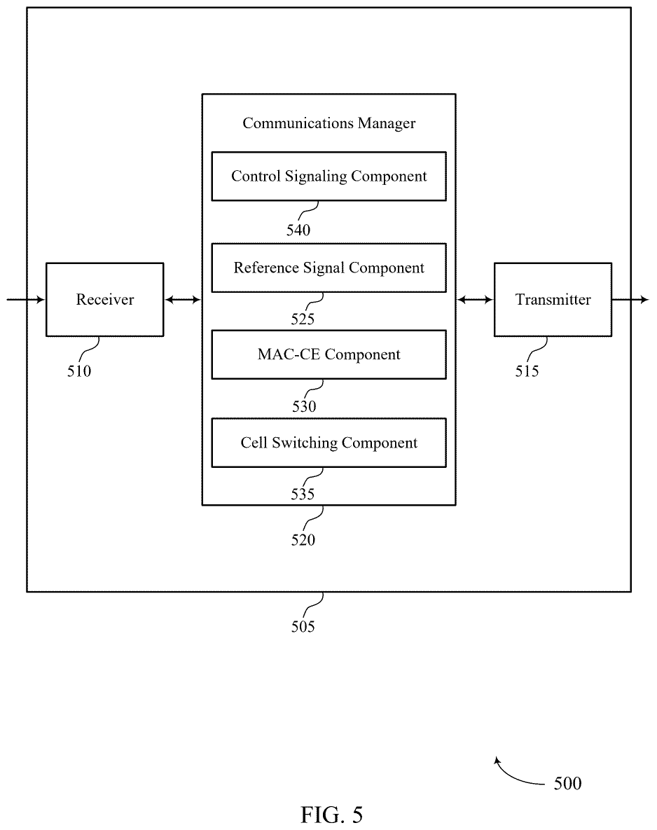

FIG. 5 shows a block diagram 500 of a device 505 that supports fast and seamless handover between TNs and NTNs in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to fast and seamless handover between TNs and NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to fast and seamless handover between TNs and NTNs). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of fast and seamless handover between TNs and NTNs as described herein. For example, the communications manager 520 may include a control signaling component 540, a reference signal component 525, a MAC-CE component 530, a cell switching component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The control signaling component 540 is capable of, configured to, or operable to support a means for receiving control signaling allocating resources for an uplink reference signal for triggering cell switching, where transmitting the uplink reference signal is based at least in part on the control signaling. The reference signal component 525 is capable of, configured to, or operable to support a means for transmitting the uplink reference signal. The MAC-CE component 530 is capable of, configured to, or operable to support a means for receiving, based on transmitting the uplink reference signal, a MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity. The cell switching component 535 is capable of, configured to, or operable to support a means for switching from a first cell associated with the first network entity to a second cell associated with the second network entity based on applying the propagation delay offset value and the pathloss offset value.

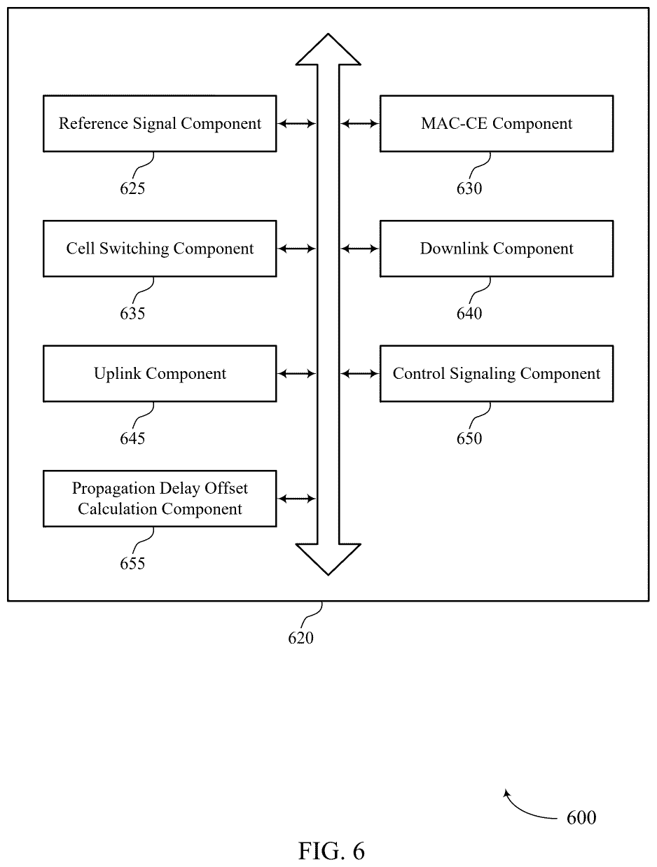

FIG. 6 shows a block diagram 600 of a communications manager 620 that supports fast and seamless handover between TNs and NTNs in accordance with one or more aspects of the present disclosure. The communications manager 620 may be an example of aspects of a communications manager 420, a communications manager 520, or both, as described herein. The communications manager 620, or various components thereof, may be an example of means for performing various aspects of fast and seamless handover between TNs and NTNs as described herein. For example, the communications manager 620 may include a reference signal component 625, a MAC-CE component 630, a cell switching component 635, a downlink component 640, an uplink component 645, a control signaling component 650, a propagation delay offset calculation component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The control signaling component 650 is capable of, configured to, or operable to support a means for receiving control signaling allocating resources for the uplink reference signal for triggering cell switching, where transmitting the uplink reference signal is based on the control signaling. The reference signal component 625 is capable of, configured to, or operable to support a means for transmitting the uplink reference signal. The MAC-CE component 630 is capable of, configured to, or operable to support a means for receiving, based on transmitting the uplink reference signal, a MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity. The cell switching component 635 is capable of, configured to, or operable to support a means for switching from a first cell associated with the first network entity to a second cell associated with the second network entity based on applying the propagation delay offset value and the pathloss offset value.

In some examples, to support transmitting the uplink reference signal, the reference signal component 625 is capable of, configured to, or operable to support a means for broadcasting a single port uplink reference signal on an omni-directional beam.

In some examples, the cell switching component 635 is capable of, configured to, or operable to support a means for adjusting a downlink reception timing in accordance with the propagation delay offset value based on applying the propagation delay offset value. In some examples, the downlink component 640 is capable of, configured to, or operable to support a means for receiving downlink signaling from the second network entity based on adjusting the downlink reception timing.

In some examples, the cell switching component 635 is capable of, configured to, or operable to support a means for adjusting an uplink transmission timing in accordance with the propagation delay offset value based on applying the propagation delay offset value. In some examples, the uplink component 645 is capable of, configured to, or operable to support a means for transmitting uplink signaling to the second network entity based on adjusting the uplink transmission timing.

In some examples, the cell switching component 635 is capable of, configured to, or operable to support a means for adjusting an uplink transmission power in accordance with the pathloss offset value based on applying the pathloss offset value. In some examples, the uplink component 645 is capable of, configured to, or operable to support a means for transmitting uplink signaling to the second network entity based on adjusting the uplink transmission power.

In some examples, the MAC-CE is a low layer triggered mobility cell switch command MAC-CE including a timing advance command field, and the timing advance command field includes the propagation delay offset value.

In some examples, the MAC-CE includes a field carrying a set of bits indicating the propagation delay offset value, a first subset of the set of bits indicating a quantity of slots of the propagation delay offset value and a second subset of the set of bits indicating a quantity of symbols of the propagation delay offset value. In some examples, the propagation delay offset value includes a sum of the quantity of slots and the quantity of symbols.

In some examples, the propagation delay offset calculation component 655 is capable of, configured to, or operable to support a means for calculating the propagation delay offset value based on the first subset of the set of bits and the second subset of the set of bits, where applying the propagation delay offset value is based on calculating the propagation delay offset value.

In some examples, one of the first network entity or the second network entity includes a non-terrestrial network entity and the other of the first network entity or the second network entity includes a terrestrial network entity.

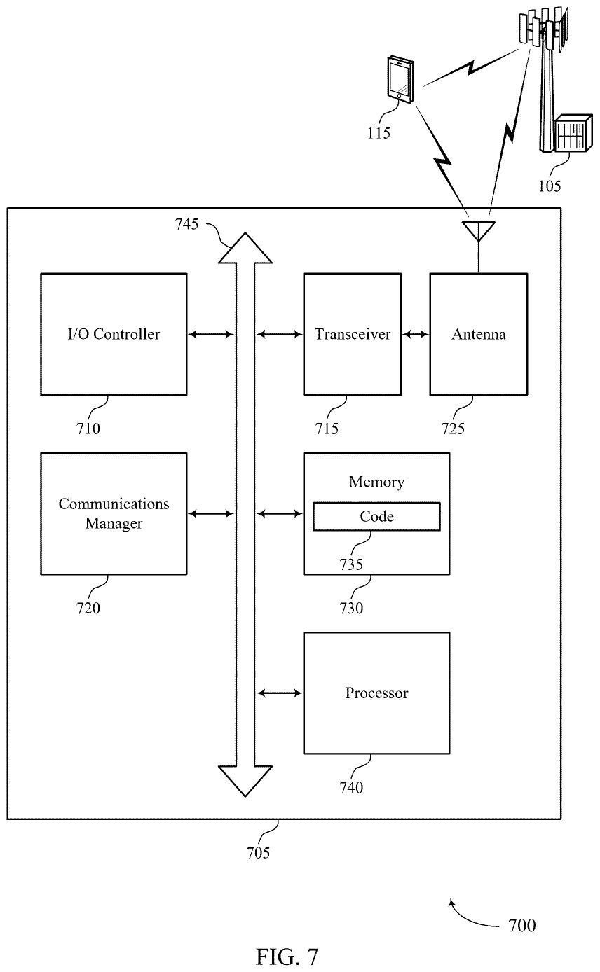

FIG. 7 shows a diagram of a system 700 including a device 705 that supports fast and seamless handover between TNs and NTNs in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting fast and seamless handover between TNs and NTNs). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving control signaling allocating resources for an uplink reference signal for triggering cell switching, where transmitting the uplink reference signal is based at least in part on the control signaling. The communications manager 720 is capable of, configured to, or operable to support a means for transmitting the uplink reference signal. The communications manager 720 is capable of, configured to, or operable to support a means for receiving, based on transmitting the uplink reference signal, a MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity. The communications manager 720 is capable of, configured to, or operable to support a means for switching from a first cell associated with the first network entity to a second cell associated with the second network entity based on applying the propagation delay offset value and the pathloss offset value.

By including or configuring the communications manager 720 in accordance with examples as described herein, the device 705 may support techniques for reduced latency and improved coordination between devices in wireless communications systems supporting collaboration and handover between a TN and an NTN.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of fast and seamless handover between TNs and NTNs as described herein, or the at least one processor 740 and the at least one memory 730 may be otherwise configured to, individually or collectively, perform or support such operations.

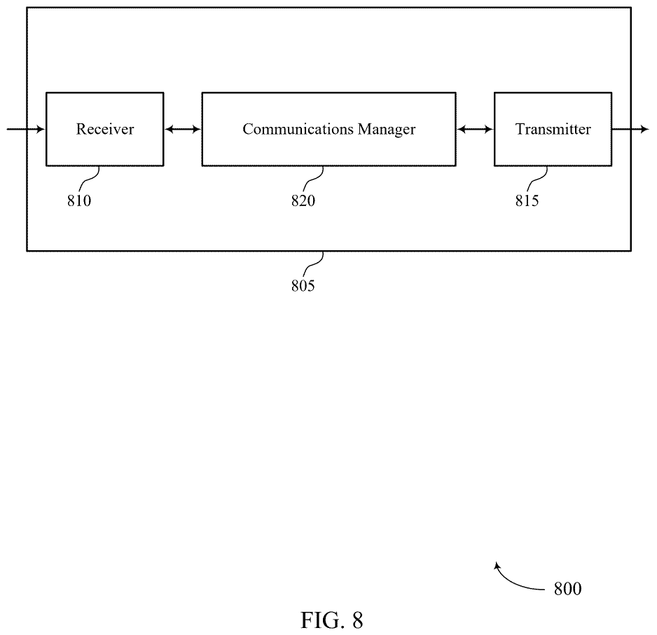

FIG. 8 shows a block diagram 800 of a device 805 that supports fast and seamless handover between TNs and NTNs in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of fast and seamless handover between TNs and NTNs as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for performing a first set of one or more measurements of an uplink reference signal received from a UE. The communications manager 820 is capable of, configured to, or operable to support a means for receiving, from a second network entity, an indication of a second set of one or more measurements of the uplink reference signal performed by the second network entity. The communications manager 820 is capable of, configured to, or operable to support a means for calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements. The communications manager 820 is capable of, configured to, or operable to support a means for transmitting a MAC-CE indicating for the UE to perform a cell switch, where the MAC-CE includes an indication of the propagation delay offset value and the pathloss offset value.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources in wireless communications systems supporting handover between a TN and an NTN.

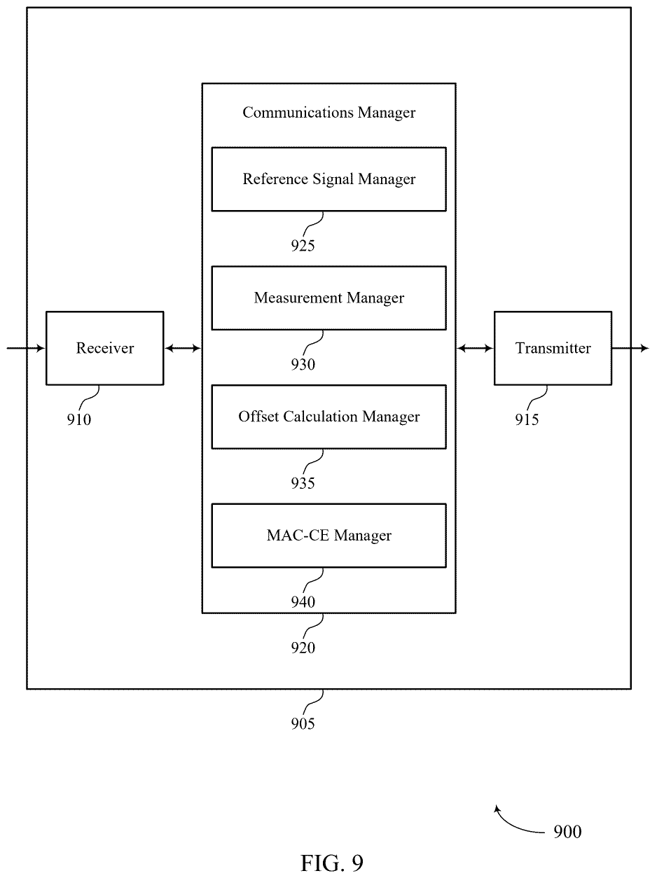

FIG. 9 shows a block diagram 900 of a device 905 that supports fast and seamless handover between TNs and NTNs in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of fast and seamless handover between TNs and NTNs as described herein. For example, the communications manager 920 may include a reference signal manager 925, a measurement manager 930, an offset calculation manager 935, a MAC-CE manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The reference signal manager 925 is capable of, configured to, or operable to support a means for performing a first set of one or more measurements of an uplink reference signal received from a UE. The measurement manager 930 is capable of, configured to, or operable to support a means for receiving, from a second network entity, an indication of a second set of one or more measurements of the uplink reference signal performed by the second network entity. The offset calculation manager 935 is capable of, configured to, or operable to support a means for calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements. The MAC-CE manager 940 is capable of, configured to, or operable to support a means for transmitting a MAC-CE indicating for the UE to perform a cell switch, where the MAC-CE includes an indication of the propagation delay offset value and the pathloss offset value.

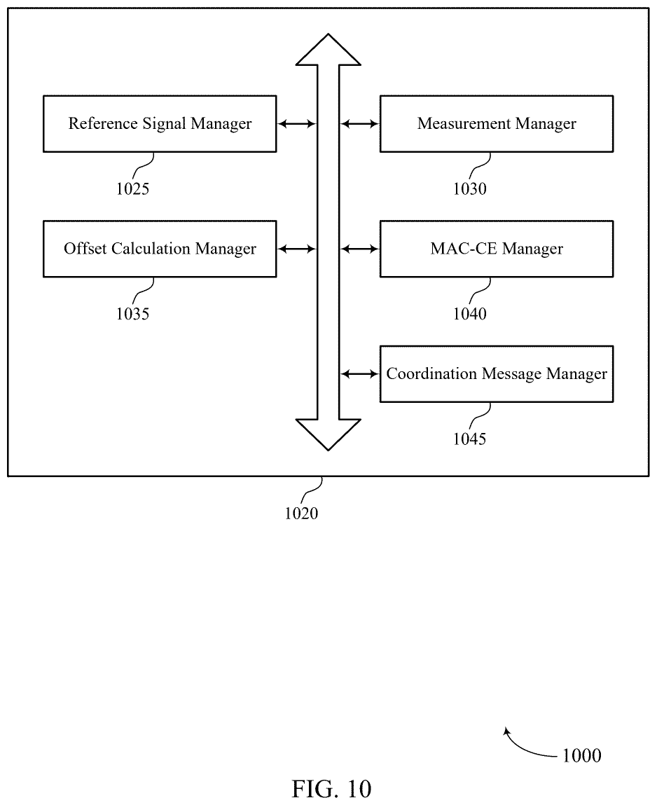

FIG. 10 shows a block diagram 1000 of a communications manager 1020 that supports fast and seamless handover between TNs and NTNs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of fast and seamless handover between TNs and NTNs as described herein. For example, the communications manager 1020 may include a reference signal manager 1025, a measurement manager 1030, an offset calculation manager 1035, a MAC-CE manager 1040, a coordination message manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The reference signal manager 1025 is capable of, configured to, or operable to support a means for performing a first set of one or more measurements of an uplink reference signal received from a UE. The measurement manager 1030 is capable of, configured to, or operable to support a means for receiving, from a second network entity, an indication of a second set of one or more measurements of the uplink reference signal performed by the second network entity. The offset calculation manager 1035 is capable of, configured to, or operable to support a means for calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements. The MAC-CE manager 1040 is capable of, configured to, or operable to support a means for transmitting a MAC-CE indicating for the UE to perform a cell switch, where the MAC-CE includes an indication of the propagation delay offset value and the pathloss offset value.

In some examples, the measurement manager 1030 is capable of, configured to, or operable to support a means for transmitting the first set of one or more measurements to the second network entity based on performing the first set of one or more measurements.

In some examples, the coordination message manager 1045 is capable of, configured to, or operable to support a means for exchanging one or more coordination messages with the second network entity via a backhaul link, where calculating the propagation delay offset value and the pathloss offset value, transmitting the MAC-CE, or both are based on the one or more coordination messages.

In some examples, one of the first network entity or the second network entity includes a non-terrestrial network entity and the other of the first network entity or the second network entity includes a terrestrial network entity.

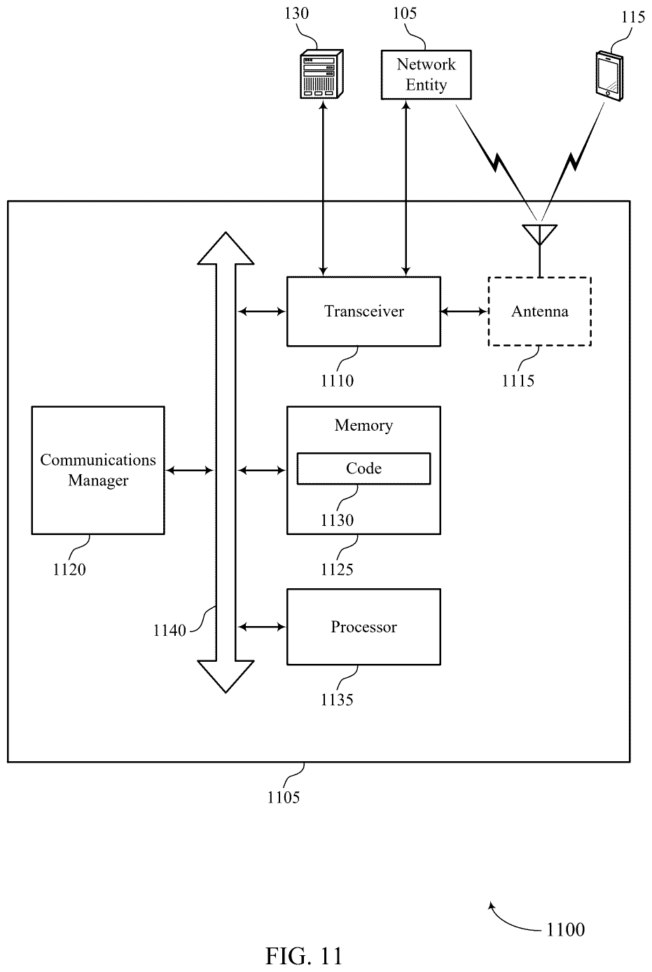

FIG. 11 shows a diagram of a system 1100 including a device 1105 that supports fast and seamless handover between TNs and NTNs in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting fast and seamless handover between TNs and NTNs). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for performing a first set of one or more measurements of an uplink reference signal received from a UE. The communications manager 1120 is capable of, configured to, or operable to support a means for receiving, from a second network entity, an indication of a second set of one or more measurements of the uplink reference signal performed by the second network entity. The communications manager 1120 is capable of, configured to, or operable to support a means for calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements. The communications manager 1120 is capable of, configured to, or operable to support a means for transmitting a MAC-CE indicating for the UE to perform a cell switch, where the MAC-CE includes an indication of the propagation delay offset value and the pathloss offset value.

By including or configuring the communications manager 1120 in accordance with examples as described herein, the device 1105 may support techniques for improved communication reliability, reduced latency, and improved coordination between devices in wireless communications systems supporting collaboration and handover between a TN and an NTN.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of fast and seamless handover between TNs and NTNs as described herein, or the at least one processor 1135 and the at least one memory 1125 may be otherwise configured to, individually or collectively, perform or support such operations.

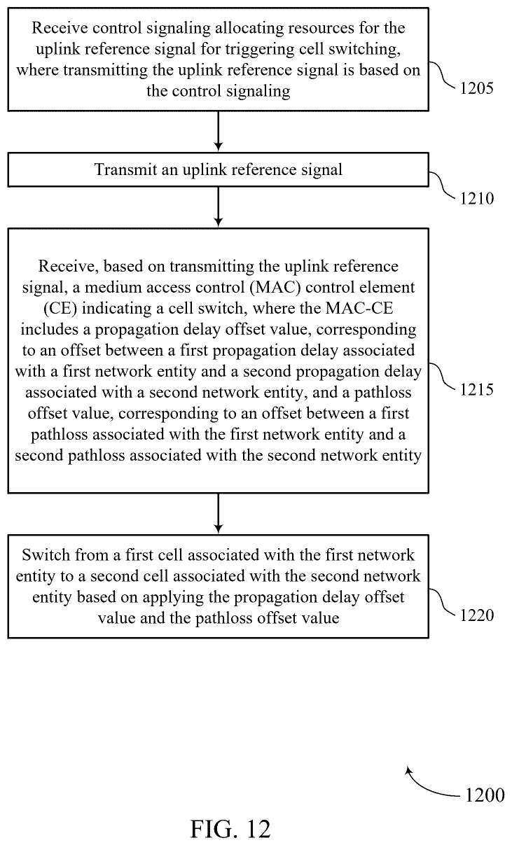

FIG. 12 shows a flowchart illustrating a method 1200 that supports fast and seamless handover between TNs and NTNs in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling allocating resources for the uplink reference signal for triggering cell switching, where transmitting the uplink reference signal is based on the control signaling. The operations of 1205 may be performed in accordance with examples as disclosed herein. In some examples, aspects of the operations of 1205 may be performed by a control signaling component 650 as described with reference to FIG. 6.

At 1210, the method may include transmitting an uplink reference signal. The operations of 1210 may be performed in accordance with examples as disclosed herein. In some examples, aspects of the operations of 1210 may be performed by a reference signal component 625 as described with reference to FIG. 6.

At 1215, the method may include receiving, based on transmitting the uplink reference signal, a MAC-CE indicating a cell switch, where the MAC-CE includes a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity. The operations of 1215 may be performed in accordance with examples as disclosed herein. In some examples, aspects of the operations of 1215 may be performed by a MAC-CE component 630 as described with reference to FIG. 6.

At 1220, the method may include switching from a first cell associated with the first network entity to a second cell associated with the second network entity based on applying the propagation delay offset value and the pathloss offset value. The operations of 1220 may be performed in accordance with examples as disclosed herein. In some examples, aspects of the operations of 1220 may be performed by a cell switching component 635 as described with reference to FIG. 6.

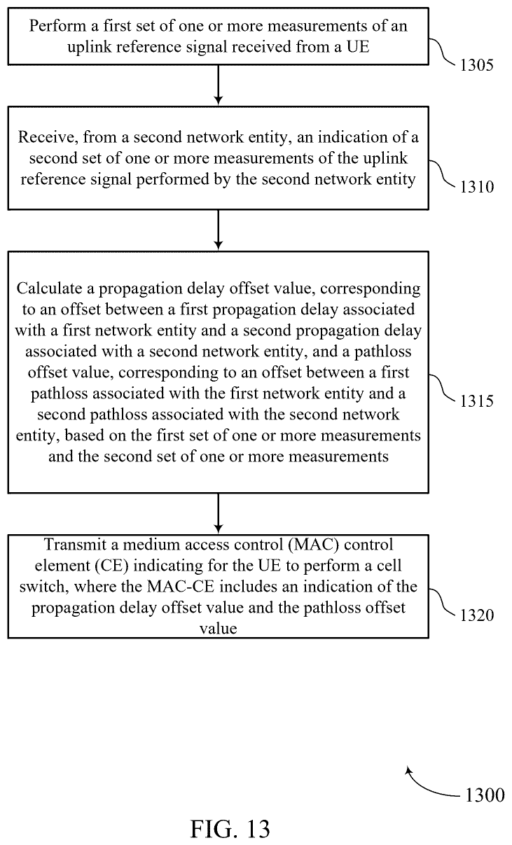

FIG. 13 shows a flowchart illustrating a method 1300 that supports fast and seamless handover between TNs and NTNs in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include performing a first set of one or more measurements of an uplink reference signal received from a UE. The operations of 1305 may be performed in accordance with examples as disclosed herein. In some examples, aspects of the operations of 1305 may be performed by a reference signal manager 1025 as described with reference to FIG. 10.

At 1310, the method may include receiving, from a second network entity, an indication of a second set of one or more measurements of the uplink reference signal performed by the second network entity. The operations of 1310 may be performed in accordance with examples as disclosed herein. In some examples, aspects of the operations of 1310 may be performed by a measurement manager 1030 as described with reference to FIG. 10.

At 1315, the method may include calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based on the first set of one or more measurements and the second set of one or more measurements. The operations of 1315 may be performed in accordance with examples as disclosed herein. In some examples, aspects of the operations of 1315 may be performed by an offset calculation manager 1035 as described with reference to FIG. 10.

At 1320, the method may include transmitting a MAC-CE indicating for the UE to perform a cell switch, where the MAC-CE includes an indication of the propagation delay offset value and the pathloss offset value. The operations of 1320 may be performed in accordance with examples as disclosed herein. In some examples, aspects of the operations of 1320 may be performed by a MAC-CE manager 1040 as described with reference to FIG. 10.

The following provides an overview of aspects of the present disclosure:

Aspect 1: A method for wireless communications by a UE, comprising: transmitting an uplink reference signal; receiving, based at least in part on transmitting the uplink reference signal, a MAC-CE indicating a cell switch, wherein the MAC-CE comprises a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity; and switching from a first cell associated with the first network entity to a second cell associated with the second network entity based at least in part on applying the propagation delay offset value and the pathloss offset value.

Aspect 2: The method of aspect 1, wherein transmitting the uplink reference signal further comprises: broadcasting a single port uplink reference signal on an omni-directional beam.

Aspect 3: The method of any of aspects 1 through 2, further comprising: adjusting a downlink reception timing in accordance with the propagation delay offset value based at least in part on applying the propagation delay offset value; and receiving downlink signaling from the second network entity based at least in part on adjusting the downlink reception timing.

Aspect 4: The method of any of aspects 1 through 3, further comprising: adjusting an uplink transmission timing in accordance with the propagation delay offset value based at least in part on applying the propagation delay offset value; and transmitting uplink signaling to the second network entity based at least in part on adjusting the uplink transmission timing.

Aspect 5: The method of any of aspects 1 through 4, further comprising: adjusting an uplink transmission power in accordance with the pathloss offset value based at least in part on applying the pathloss offset value; and transmitting uplink signaling to the second network entity based at least in part on adjusting the uplink transmission power.

Aspect 6: The method of any of aspects 1 through 5, further comprising: receiving control signaling allocating resources for the uplink reference signal for triggering cell switching, wherein transmitting the uplink reference signal is based at least in part on the control signaling.

Aspect 7: The method of any of aspects 1 through 6, wherein the MAC-CE is a low layer triggered mobility cell switch command MAC-CE comprising a timing advance command field, and the timing advance command field comprises the propagation delay offset value.

Aspect 8: The method of any of aspects 1 through 7, wherein the MAC-CE comprises a field carrying a set of bits indicating the propagation delay offset value, a first subset of the set of bits indicating a quantity of slots of the propagation delay offset value and a second subset of the set of bits indicating a quantity of symbols of the propagation delay offset value, and the propagation delay offset value comprises a sum of the quantity of slots and the quantity of symbols.

Aspect 9: The method of aspect 8, further comprising: calculating the propagation delay offset value based at least in part on the first subset of the set of bits and the second subset of the set of bits, wherein applying the propagation delay offset value is based at least in part on calculating the propagation delay offset value.

Aspect 10: The method of any of aspects 1 through 9, wherein one of the first network entity or the second network entity comprises a non-terrestrial network entity and the other of the first network entity or the second network entity comprises a terrestrial network entity.

Aspect 11: A method for wireless communications by a first network entity, comprising: performing a first set of one or more measurements of an uplink reference signal received from a UE; receiving, from a second network entity, an indication of a second set of one or more measurements of the uplink reference signal performed by the second network entity; calculating a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based at least in part on the first set of one or more measurements and the second set of one or more measurements; and transmitting a medium access control (MAC) control element (CE) indicating for the UE to perform a cell switch, wherein the MAC-CE comprises an indication of the propagation delay offset value and the pathloss offset value.

Aspect 12: The method of aspect 11, further comprising: transmitting the first set of one or more measurements to the second network entity based at least in part on performing the first set of one or more measurements.

Aspect 13: The method of any of aspects 11 through 12, further comprising: exchanging one or more coordination messages with the second network entity via a backhaul link, wherein calculating the propagation delay offset value and the pathloss offset value, transmitting the MAC-CE, or both are based at least in part on the one or more coordination messages.

Aspect 14: The method of any of aspects 11 through 13, wherein one of the first network entity or the second network entity comprises a non-terrestrial network entity and the other of the first network entity or the second network entity comprises a terrestrial network entity.

Aspect 15: A UE for wireless communications, comprising one or more memories storing processor-executable code, and one or more processors coupled with the one or more memories and individually or collectively operable to execute the code to cause the UE to perform a method of any of aspects 1 through 10.

Aspect 16: A UE for wireless communications, comprising at least one means for performing a method of any of aspects 1 through 10.

Aspect 17: A non-transitory computer-readable medium storing code for wireless communications, the code comprising instructions executable by one or more processors to perform a method of any of aspects 1 through 10

Aspect 18: A first network entity for wireless communications, comprising one or more memories storing processor-executable code, and one or more processors coupled with the one or more memories and individually or collectively operable to execute the code to cause the first network entity to perform a method of any of aspects 11 through 14.

Aspect 19: A first network entity for wireless communications, comprising at least one means for performing a method of any of aspects 11 through 14.

Aspect 20: A non-transitory computer-readable medium storing code for wireless communications, the code comprising instructions executable by one or more processors to perform a method of any of aspects 11 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling allocating resources for an uplink reference signal for triggering cell switching, wherein transmitting the uplink reference signal is based at least in part on the control signaling;
transmit the uplink reference signal via the allocated resources;
receive, based at least in part on transmitting the uplink reference signal, a medium access control (MAC) control element (CE) indicating a cell switch, wherein the MAC-CE comprises a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity; and
switch from a first cell associated with the first network entity to a second cell associated with the second network entity based at least in part on applying the propagation delay offset value and the pathloss offset value.

2. The UE of claim 1, wherein, to transmit the uplink reference signal, the one or more processors are individually or collectively further operable to execute the code to cause the UE to:
broadcast a single port uplink reference signal on an omni-directional beam.

3. The UE of claim 1, wherein the one or more processors are individually or collectively further operable to execute the code to cause the UE to:
adjust a downlink reception timing in accordance with the propagation delay offset value based at least in part on applying the propagation delay offset value; and
receive downlink signaling from the second network entity based at least in part on adjusting the downlink reception timing.

4. The UE of claim 1, wherein the one or more processors are individually or collectively further operable to execute the code to cause the UE to:
adjust an uplink transmission timing in accordance with the propagation delay offset value based at least in part on applying the propagation delay offset value; and
transmit uplink signaling to the second network entity based at least in part on adjusting the uplink transmission timing.

5. The UE of claim 1, wherein the one or more processors are individually or collectively further operable to execute the code to cause the UE to:
adjust an uplink transmission power in accordance with the pathloss offset value based at least in part on applying the pathloss offset value; and
transmit uplink signaling to the second network entity based at least in part on adjusting the uplink transmission power.

6. The UE of claim 1, wherein the MAC-CE is a low layer triggered mobility cell switch command MAC-CE comprising a timing advance command field, and the timing advance command field comprises the propagation delay offset value.

7. The UE of claim 1, wherein the MAC-CE comprises a field carrying a set of bits indicating the propagation delay offset value, a first subset of the set of bits indicating a quantity of slots of the propagation delay offset value and a second subset of the set of bits indicating a quantity of symbols of the propagation delay offset value, and the propagation delay offset value comprises a sum of the quantity of slots and the quantity of symbols.

8. The UE of claim 7, wherein the one or more processors are individually or collectively further operable to execute the code to cause the UE to:
calculate the propagation delay offset value based at least in part on the first subset of the set of bits and the second subset of the set of bits, wherein applying the propagation delay offset value is based at least in part on calculating the propagation delay offset value.

9. The UE of claim 1, wherein one of the first network entity or the second network entity comprises a non-terrestrial network entity and the other of the first network entity or the second network entity comprises a terrestrial network entity.

10. A first network entity, comprising:
one or more memories storing processor-executable code; and
one or more processors coupled with the one or more memories and individually or collectively operable to execute the code to cause the first network entity to:
perform a first set of one or more measurements of an uplink reference signal received from a user equipment (UE);
receive, from a second network entity, an indication of a second set of one or more measurements of the uplink reference signal performed by the second network entity;
calculate a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity, based at least in part on the first set of one or more measurements and the second set of one or more measurements; and
transmit a medium access control (MAC) control element (CE) indicating for the UE to perform a cell switch, wherein the MAC-CE comprises an indication of the propagation delay offset value and the pathloss offset value.

11. The first network entity of claim 10, wherein the one or more processors are individually or collectively further operable to execute the code to cause the first network entity to:
transmit the first set of one or more measurements to the second network entity based at least in part on performing the first set of one or more measurements.

12. The first network entity of claim 10, wherein the one or more processors are individually or collectively further operable to execute the code to cause the first network entity to:
exchange one or more coordination messages with the second network entity via a backhaul link, wherein calculating the propagation delay offset value and the pathloss offset value, transmitting the MAC-CE, or both are based at least in part on the one or more coordination messages.

13. The first network entity of claim 10, wherein one of the first network entity or the second network entity comprises a non-terrestrial network entity and the other of the first network entity or the second network entity comprises a terrestrial network entity.

14. A method for wireless communications by a user equipment (UE), comprising:
receiving control signaling allocating resources for an uplink reference signal for triggering cell switching, wherein transmitting the uplink reference signal is based at least in part on the control signaling;
transmitting the uplink reference signal via the allocated resources;
receiving, based at least in part on transmitting the uplink reference signal, a medium access control (MAC) control element (CE) indicating a cell switch, wherein the MAC-CE comprises a propagation delay offset value, corresponding to an offset between a first propagation delay associated with a first network entity and a second propagation delay associated with a second network entity, and a pathloss offset value, corresponding to an offset between a first pathloss associated with the first network entity and a second pathloss associated with the second network entity; and
switching from a first cell associated with the first network entity to a second cell associated with the second network entity based at least in part on applying the propagation delay offset value and the pathloss offset value.

15. The method of claim 14, wherein transmitting the uplink reference signal further comprises:
broadcasting a single port uplink reference signal on an omni-directional beam.

16. The method of claim 14, further comprising:
adjusting a downlink reception timing in accordance with the propagation delay offset value based at least in part on applying the propagation delay offset value; and
receiving downlink signaling from the second network entity based at least in part on adjusting the downlink reception timing.

17. The method of claim 14, further comprising:
adjusting an uplink transmission timing in accordance with the propagation delay offset value based at least in part on applying the propagation delay offset value; and
transmitting uplink signaling to the second network entity based at least in part on adjusting the uplink transmission timing.

18. The method of claim 14, further comprising:
adjusting an uplink transmission power in accordance with the pathloss offset value based at least in part on applying the pathloss offset value; and
transmitting uplink signaling to the second network entity based at least in part on adjusting the uplink transmission power.

19. The method of claim 14, wherein the MAC-CE is a low layer triggered mobility cell switch command MAC-CE comprising a timing advance command field, and the timing advance command field comprises the propagation delay offset value.

20. The method of claim 14, wherein one of the first network entity or the second network entity comprises a non-terrestrial network entity and the other of the first network entity or the second network entity comprises a terrestrial network entity.
